(19) United States
(12) Patent Application Publication
(10) Pub. No.: US 2007/0163706 A1
(43) Pub. Date: Jul. 19, 2007

(54) Method of bonding different kinds of gemstones

(76) Inventor: Yong Sun Hong, Seoul (KR)

Correspondence Address: DARBY & DARBY P.C., P. O. BOX 5257, NEW YORK, NY, 10150-5257, US

(21) Appl. No.: 11/334,986

(22) Filed: Jan. 18, 2006

(51) Int. Cl. B32B 38/04; B32B 37/12; B26D 1/00

(52) U.S. Cl. 156/250; 83/929; 83/13

(57) ABSTRACT

Disclosed herein is a method of bonding different kinds of gemstones to provide gems having maximum beautiful appearance. The method of this invention includes mixing a binder and a curing agent in liquid phases at a mixing ratio of 90˜110:40˜60 to obtain a mixture of binder and curing agent; applying the mixture of binder and curing agent onto bonding surfaces of different kinds of gemstones, and then drying/curing the applied mixture at 50˜180° C. for 2˜15 min to obtain a gemstone body composed of different kinds of gemstones bonded together; and cutting the gemstone body.

### BACKGROUND OF THE INVENTION

1. Field of the Invention

The present invention relates, generally, to a gemstone bonding method, and more particularly, to a method of bonding different kinds of gemstones to provide gems having maximum beautiful appearance.

2. Description of the Related Art

In general, minerals or synthetic stones (hereinafter, referred to as ‘gemstones’), such as crystals, sapphires, emeralds, cubic zirconia, rubies, etc., are cut to manufacture jewelry, including necklaces, earrings, bracelets, accessories, etc. The cut gemstone has a plurality of facets by the degree of cutting, such that light leaving a gem is refracted or reflected to various angles, thereby exhibiting beautiful appearance. Further, such a gem may be applied to jewelry by holding it in place in an alloy bezel, or may be used alone.

However, since the jewelry using such mineral stones is expensive, it is composed mainly of one kind of gem, resulting in simplified function and beauty. Moreover, limitations are imposed on satisfying the demand of consumers requiring various kinds of gems.

### SUMMARY OF THE INVENTION

Accordingly, the present invention has been made keeping in mind the above problems occurring in the related art, and an object of the present invention is to provide a method of bonding different kinds of gemstones to maximize the beautiful appearance of gems.

In order to accomplish the above object, the present invention provides a method of bonding different kinds of gemstones, comprising steps of: mixing a binder and a curing agent in liquid phases at a mixing ratio of 90˜110:40˜60 to obtain a mixture of binder and curing agent; applying the mixture of binder and curing agent onto bonding surfaces of different kinds of gemstones, and then drying/curing the applied mixture at 50˜180° C. for 2˜15 min to obtain a gemstone body composed of different kinds of gemstones bonded together; and cutting the gemstone body.

In the method of the present invention, the mixing ratio in the mixing step is preferably 100:50.

In addition, the drying/curing step is preferably conducted at 110° C.

### BRIEF DESCRIPTION OF THE DRAWINGS

FIG. 1 is a flowchart showing a process of bonding different kinds of gemstones according to the present invention;

FIG. 2 is a perspective view showing a gem composed of different kinds of gemstones bonded and then cut, according to the present invention; and

FIG. 3 is a perspective view showing another gem composed of different kinds of gemstones bonded and then cut, according to the present invention.

### DETAILED DESCRIPTION OF THE INVENTION

Hereinafter, a detailed description will be given of the present invention with reference to the appended drawings.

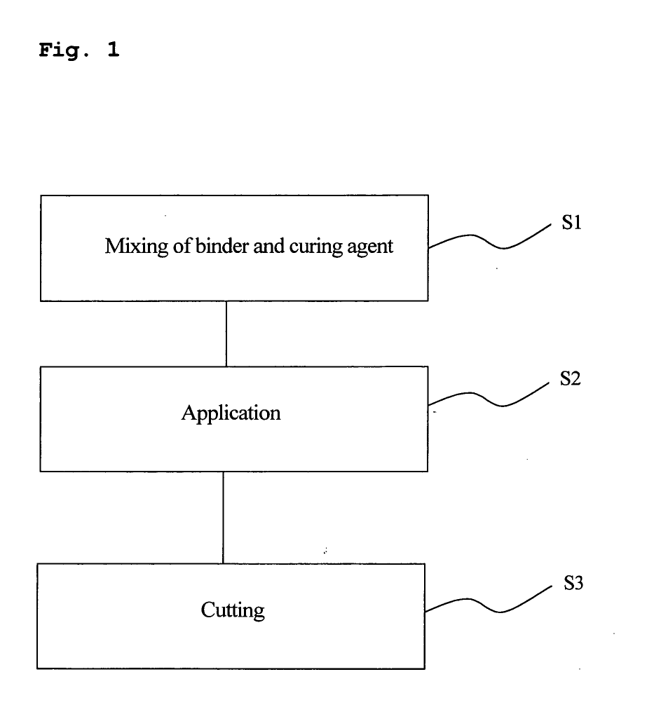

FIG. 1 shows a process of bonding different kinds of gemstones according to the present invention.

As shown in FIG. 1, the gemstone bonding method of the present invention comprises steps of mixing a binder and a curing agent at an appropriate mixing ratio (S1), applying the mixture of binder and curing agent onto the bonding surfaces of different kinds of gemstones and then drying/curing it (S2), and cutting the bonded gemstones (S3).

In the mixing step (S1), the liquid binder and curing agent are mixed together at the mixing ratio of 90˜110:40˜60, and preferably of 100:50.

The properties of the binder and curing agent used in the present invention are summarized in Table 1 below.

TABLE 1

| Properties | Binder | Curing Agent |
|---|---|---|
| Outer Appearance | Colorless, Opaque | Yellow, Transparent |
| Viscosity | About 400 dpa's | About 300 dpa's |
| Substrate | Epoxy Resin | Aliphatic Amine |
| Solvent | No | No |
| Concentration | About 1.2 | About 0.96 |
| Burning Point | About 250° C. | About 250° C. |

The components of binder and curing agent of the present invention are not limited to those shown in Table 1, and may vary with various environments.

In the drying/curing step (S2), the mixture of binder and curing agent mixed in the mixing step (S1) is applied onto the bonding surfaces of different kinds of gemstones, and then cured in a drying oven. The drying process is conducted at 50˜180° C. for 2˜15 min. As an experimental result of the present invention, although the drying process may be affected by the sizes of gemstones, it is preferably conducted at 110° C. The temperature and period of time required for the drying process may vary depending on the sizes of gemstones.

In the cutting step (S3), the gemstone body, in which the different kinds of gemstones are bonded by being cured in the drying/curing step (S2), is cut according to a variety of cutting processes, therefore obtaining a gem having maximum beautiful appearance.

The gemstone body composed of different kinds of gemstones bonded using the bonding method of the present invention is advantageous because of exhibiting excellent bonding strength and high heat resistance, endurable even at high cutting temperatures of 250° C. or more.

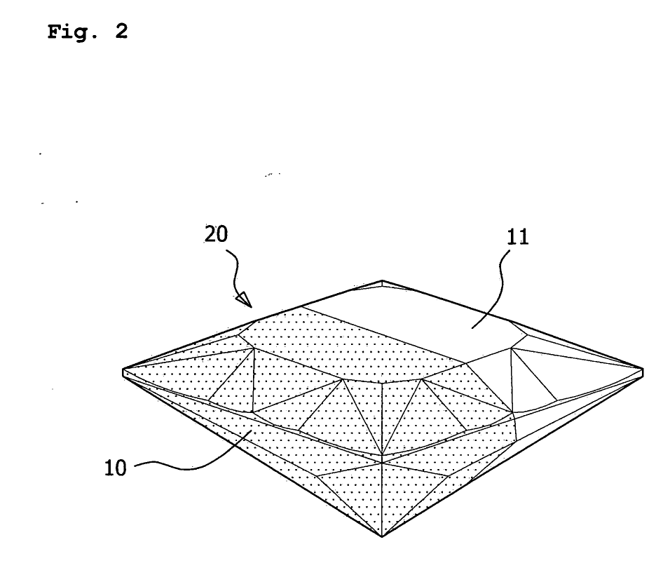

Turning now to FIG. 2, there is illustrated a gem according to a first embodiment of the present invention, in which the gem is obtained by bonding the different kinds of gemstones using the gemstone bonding method of the present invention and then cutting the bonded gemstone body. Specifically, as shown in FIG. 2, a first gemstone 10 and a second gemstone 11 are bonded together and then cut through various cutting processes, thereby obtaining a gem 20 having maximum beautiful appearance.

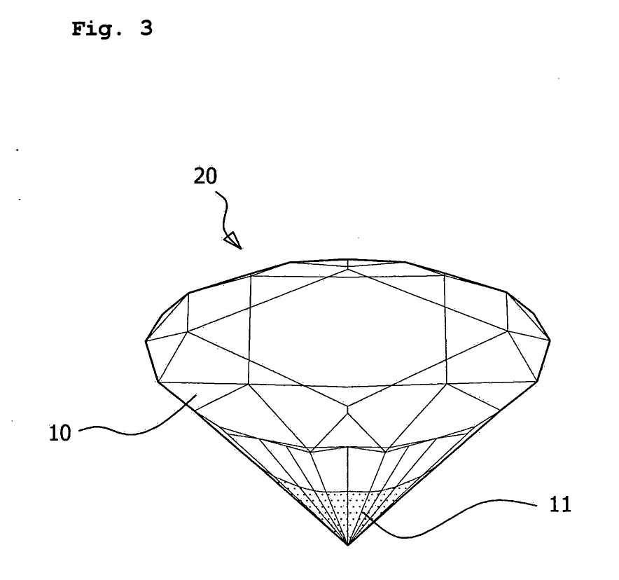

FIG. 3 shows another gem according to the present invention.

As previously described herein, the present invention provides a method of bonding different kinds of gemstones. According to the method of the present invention, the beautiful appearance of gems can be maximized, and as well the demand of consumers requiring various kinds of gems can be satisfied.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

What is claimed is:

1. A method of bonding different kinds of gemstones, comprising steps of:
mixing a binder and a curing agent in liquid phases at a mixing ratio of 90˜110:40˜60, to obtain a mixture of binder and curing agent;
applying the mixture of binder and curing agent onto bonding surfaces of different kinds of gemstones, and then drying/curing the applied mixture at 50˜180° C. for 2˜15 min, to obtain a gemstone body composed of different kinds of gemstones bonded together; and
cutting the gemstone body.

2. The method as set forth in claim 1, wherein the mixing ratio of the binder and curing agent in the mixing step is 100:50.

3. The method as set forth in claim 1, wherein the drying/curing step is conducted at 110° C.
